(19) United States
(12) Patent Application Publication
(10) Pub. No.: US 2010/0216632 A1
(43) Pub. Date: Aug. 26, 2010

(54) High Stability, Self-Protecting Electrocatalyst Particles

(75) Inventors: Radoslav Adzic, East Setauket, NY (US); Miomir Vukmirovic, Port Jefferson Station, NY (US); Weiping Zhou, Rocky Point, NY (US)

Correspondence Address: BROOKHAVEN SCIENCE ASSOCIATES/;BROOKHAVEN NATIONAL LABORATORY, BLDG. 490C - P.O. BOX 5000, UPTON, NY, 11973, US

(73) Assignee: Brookhaven Science Associates, LLC, Upton, NY (US)

(21) Appl. No.: 12/709,910

(22) Filed: Feb. 22, 2010

Related U.S. Application Data
(60) Provisional application No. 61/155,196, filed on Feb. 25, 2009.

(51) Int. Cl. B01J 23/42; B01J 21/18; H01M 4/88

(52) U.S. Cl. 502/101; 502/185; 977/773

(57) ABSTRACT

High-stability, self-protecting particles encapsulated by a thin film of a catalytically active noble metal are described. The particles are preferably nanoparticles comprising a passivating element having at least one metal selected from the group consisting of columns IVB, VB, VIB, and VIIB of the periodic table. The nanoparticle is preferably encapsulated by a Pt shell and may be either a nanoparticle alloy or a core-shell nanoparticle. The nanoparticle alloys preferably have a core comprised of a passivating component alloyed with at least one other transition metal. The core-shell nanoparticles comprise a core of a non-noble metal surrounded by a shell of a noble metal. The material constituting the core, shell, or both the core and shell may be alloyed with one or more passivating elements. The self-protecting particles are ideal for use in corrosive environments where they exhibit improved stability compared to conventional electrocatalyst particles.

### CROSS-REFERENCE TO RELATED APPLICATIONS

This application claims priority under 35 U.S.C. §119(e) to U.S. Provisional Patent Application No. 61/155,196 which was filed on Feb. 25, 2009, the entirety of which is incorporated by reference as if fully set forth in this specification.

### STATEMENT OF GOVERNMENT RIGHTS

This invention was made with Government support under contract number DE-AC02-98CH10886 awarded by the U.S. Department of Energy. The Government has certain rights in the invention.

### BACKGROUND

I. Field of the Invention

This invention relates generally to self-protecting electrocatalyst particles. The present invention also relates to the controlled deposition of a catalytically active metal film on high-stability, self-protecting electrocatalyst particles. This invention further relates to the use of these electrocatalyst particles in energy conversion devices such as fuel cells.

II. Background of the Related Art

A fuel cell is an electrochemical device capable of converting the chemical energy of a fuel and an oxidant into electrical energy. A standard fuel cell is comprised of an anode and cathode separated by a conducting electrolyte which electrically insulates the electrodes yet permits the flow of ions between them. The fuel cell operates by separating electrons and ions from the fuel at the anode and transporting the electrons through an external circuit to the cathode. The ions are concurrently transported through the electrolyte to the cathode where the oxidant is combined with the ions and electrons to form a waste product. An electrical circuit is completed by the concomitant flow of ions from the anode to cathode via the conducting electrolyte and the flow of electrons from the anode to the cathode via the external circuit.

The science and technology of fuel cells has received considerable attention, being the subject of numerous books and journal articles including, for example, “Fuel Cells and Their Applications,” by K. Kordesch and G. Simader, New York, N.Y.: VCH Publishers, Inc. (2001). Although there are various types of fuels and oxidants which may be used, the most significant is the hydrogen-oxygen system. In a hydrogen-oxygen fuel cell, hydrogen (H₂) is supplied to the anode as the fuel where it dissociates into H⁺ ions and provides electrons to the external circuit. Oxygen (O₂) supplied to the cathode undergoes a reduction reaction in which O₂ combines with electrons from the external circuit and ions in the electrolyte to form H₂O as a byproduct. The overall reaction pathways leading to oxidation at the anode and reduction at the cathode are strongly dependent on the materials used as the electrodes and the type of electrolyte.

Under standard operating conditions the H₂ and O₂ oxidation/reduction reactions proceed very slowly, if at all, requiring elevated temperatures and/or high electrode potentials to proceed. Reaction kinetics at the electrodes may be accelerated by the use of noble metals such as platinum (Pt), palladium (Pd), ruthenium (Ru), and related alloys. Electrodes formed of these materials function as electrocatalysts since they accelerate electrochemical reactions at electrode surfaces yet are not themselves consumed by the overall reaction. Further improvements have been attained by incorporating noble metal-containing particles or structures with reduced dimensions. A reduction to nanoscale dimensions yields a significant increase in the surface-to-volume ratio, producing a concomitant increase in the surface area available for reaction. Despite the performance improvements attainable with nanoscale electrocatalysts, successful commercialization of fuel cells requires still further increases in performance, stability, and cost efficiency.

Pt has been shown to be one of the best electrocatalysts, but its successful implementation in commercially available fuel cells is hindered by its high cost, susceptibility to carbon monoxide (CO) poisoning, poor stability under cyclic loading, and the relatively slow kinetics of O₂ reduction at the cathode. A variety of approaches have been employed in attempting to solve these problems. An example is U.S. Pat. No. 6,232,264 to Lukehart, et al. which discloses polymetallic nanoparticles such as platinum-palladium alloy nanoparticles for use as fuel cell electrocatalysts. Another example is U.S. Pat. No. 6,670,301 to Adzic, et al. which discloses a process for depositing a thin film of Pt on dispersed Ru nanoparticles supported on carbon (C) substrates. These approaches have resulted in electrocatalysts with reduced Pt loading and a higher tolerance for CO poisoning. Both of the aforementioned patents are incorporated by reference as if fully set forth in this specification.

Attempts to accelerate the oxygen reduction reaction (ORR) on Pt while simultaneously reducing Pt loading have been met with limited success. Recent approaches have utilized high surface area Pt or Pd nanoparticles supported by nanostructured carbon (Pt/C or Pd/C) as described, for example, in U.S. Pat. No. 6,815,391 to Xing, et al., which is incorporated by reference as if fully set forth in this specification. However, as an oxygen reduction catalyst, bulk Pt is still several times more active than Pt/C and Pd/C nanoparticle electrocatalysts. Another approach involves the use of Pt-encapsulated core-shell or alloy nanoparticles as described, for example, in U.S. Patent Publ. No. 2007/0031722 to Adzic, et al., which is incorporated by reference as if fully set forth in this specification. The quantity of noble metal required was reduced even further by using a core-shell nanoparticle with a noble metal shell, but a non-noble metal core. Despite the continued improvement attained with Pt-based electrocatalysts, successful implementation in commercial energy conversion devices such as fuel cells requires still further increases in the catalytic activity while simultaneously improving long-term stability and reducing the amount of costly precious metals required.

### SUMMARY

In view of the above-described problems, needs, and goals, in one embodiment of the present invention a self-protecting electrocatalyst with high stability is provided. It has been discovered that non-noble metal particles may exhibit reduced stability when used with corrosive materials such as may be found in an energy conversion device. If the non-noble metal component is not completely encapsulated by a noble metal, the non-noble metal may be subject to dissolution in a corrosive environment. This may occur, for example, due to exposure to the acidic or alkaline solution comprising the electrolyte in a fuel cell. In one embodiment, this problem is solved by synthesizing high-stability, self-protecting electro catalysts supports with a component that easily passivates. An example of a support that passivates is a binary metal alloy. This may be expressed as Tr₁₋ₓPsₓ where Tr is a transition metal and Ps is a passivating metal. The individual amounts (x) and (1−x) of each element may be adjusted over the range 0<x<1 to obtain a compound with the desired structure, phase, and properties as may generally be determined from a binary alloy phase diagram of the constituent elements. The passivating metal is preferably an element from column IVB, VB, VIB, or VIIB of the periodic table which correspond to groups 4 through 7, respectively. The passivating component(s) therefore preferably comprise the metals titanium (Ti), hafnium (Hf), zirconium (Zr), tungsten (W), tantalum (Ta), niobium (Nb), vanadium (V), rhenium (Re), molybdenum (Mo), technetium (Tc), chromium (Cr), and manganese (Mn). One or a combination of the aforementioned metals may be used along with the primary materials constituting the electrocatalyst.

The electrocatalyst is preferably a particle having dimensions ranging from 1-100 nm and is thus a nanoparticle, but is not so limited. Particles extending into the micrometer or even millimeter size range may also be used. The electrocatalyst preferably comprises a nanoparticle covered by a contiguous thin layer of a catalytically active noble metal with a surface coverage ranging from less than a monolayer (ML) to several MLs. The catalytically active noble metal can be Ru, rhodium (Rh), Pd, osmium (Os), iridium (Ir), Pt, or gold (Au), but is preferably Pt. In an especially preferred embodiment, the electrocatalyst is a nanoparticle having a Pt surface coverage of one ML. The nanoparticle itself may comprise either a nanoparticle alloy or a core-shell nanoparticle which is covered with a catalytically active noble metal. The electrocatalyst is therefore preferably either a Pt-coated nanoparticle alloy or a Pt-coated core-shell nanoparticle.

In one embodiment, the nanoparticle comprises at least one element from column IVB, VB, VIB, or VIIB of the periodic table which is alloyed with one or more other transition metals. The thus-formed alloy is preferably homogeneous, but may have compositional and structural nonuniformities. The passivating component is preferably present in a minimum concentration sufficient to passivate exposed non-noble metal core surfaces and inhibit corrosion of the nanoparticle alloy core. In this embodiment the electrocatalyst is preferably a Pt-coated nanoparticle alloy core in which the core is a homogeneous solid solution comprising at least one element from column IVB, VB, VIB, or VIIB of the periodic table.

In another embodiment, the nanoparticle is a core-shell nanoparticle in which a core comprising one or more element from column IVB, VB, VIB, or VIIB of the periodic table is alloyed with one or more other transition metals and is encapsulated by a shell of one or more noble metals. The noble metal shell is atomically thin, i.e. less than one to several MLs thick. The noble metal shell is preferably at least a ML thick, but is not so limited and may be several atomic layers. The composition of the core itself is preferably homogeneous, but may be nonuniform. The passivating component is preferably present in a minimum concentration sufficient to passivate exposed non-noble metal regions of core surface and thus inhibit corrosion of the underlying core, but is not so limited. In this embodiment the catalyst is preferably a Pt-coated core-shell nanoparticle in which the core is a homogeneous alloy comprising at least one element from column IVB, VB, VIB, or VIIB of the periodic table and the shell is a monolayer of a noble metal.

In still another embodiment, the particle is a core-shell nanoparticle in which a core comprising a transition metal is encapsulated by a shell of one or more noble metals alloyed with one or more elements from columns IVB, VB, VIB, or VIIB of the periodic table. The noble metal shell is preferably at least a ML thick, but may be several MLs. The composition of the shell is preferably homogeneous, but may be nonuniform. The passivating component is preferably present in a minimum concentration sufficient to passivate the core surface and thus inhibit corrosion of the underlying core, but is not so limited. In this embodiment the catalyst is preferably a Pt-coated core-shell nanoparticle in which the core is a transition metal and the shell is a ML of at least one noble metal which is preferably Pd either alone or alloyed with at least one element from column IVB, VB, VIB, or VIIB of the periodic table. This interlayer of Pd makes the core or core-shell surface suitable for interacting with Pt to promote its activity for the oxidation reduction reaction (ORR).

In yet another embodiment, the particle is a core-shell nanoparticle in which both the core and shell are separately alloyed with one or more elements from columns IVB, VB, VIB, or VIIB of the periodic table. The core comprises at least one transition metal alloyed with at least one passivating element whereas the shell is at least one noble metal similarly alloyed with at least one passivating element. In this manner the passivating component is present in both the core and the shell of a core-shell nanoparticle.

An additional embodiment relates to the utilization of these high-stability, self-protecting Pt-coated nanoparticle alloys or Pt-coated core-shell nanoparticles in the electrodes of a fuel cell. In a preferred embodiment, the self-protecting Pt-coated nanoparticle electrodes are used as the cathode to accelerate ORR kinetics.

### BRIEF DESCRIPTION OF THE DRAWINGS

FIG. 1A is a cross-sectional schematic of a nanoparticle alloy in which the core comprises a homogeneous alloy having a passivating element;

FIG. 1B shows a cross-sectional schematic of a core-shell nanoparticle in which the core comprises a homogeneous alloy having a passivating element and the shell is a noble metal;

FIG. 1C is a cross-sectional schematic of a core-shell nanoparticle in which the core comprises a transition metal and the shell is a noble metal alloyed with a passivating element;

FIG. 1D is a cross-sectional schematic of a core-shell nanoparticle in which both the core and the shell are alloyed with a passivating element;

FIG. 2 shows a series of images illustrating the underpotential deposition of a Cu adlayer onto a nanoparticle followed by the galvanic displacement of Cu atoms by Pt; and

FIG. 3 is an illustration of a Pt-encapsulated nanoparticle alloy in which the core comprises a homogeneous alloy with a passivating element;

FIG. 4 is an illustration of a Pt-encapsulated nanoparticle with an interlayer of Pd or another noble metal in which the core comprises a homogeneous alloy with a passivating element;

FIG. 5 is a transmission electron microscopy image of carbon-supported Pd₃Ti nanoparticles (Pd₃Ti/C) showing a typical structure and size distribution;

FIG. 6 shows a plot of the intensity of the diffracted X-ray signal as a function of 2θ for Pd₃Ti/C and Pd/C nanoparticles;

FIG. 7 is a plot showing a comparison of polarization curves for oxygen reduction on Pt/C (left curve) and Pt/Pd₃Ti/C (right curve) nanoparticles;

FIG. 8 shows a bar graph comparing the Pt mass-specific activities of commercial Pt/C nanoparticles and Pt/Pd₃Ti/C nanoparticles expressed as the current jₖ in mA/μg at 0.90 V;

FIG. 9 is a plot comparing X-ray diffraction spectra obtained for PdRe/C annealed in a H₂ ambient at 800° C. for 3 hours (top curve) and at 600° C. for 3 hours (middle curve) with commercial Pd/C nanoparticles;

FIG. 10 shows a bar graph comparing the Pt mass-specific activities of commercial Pt/C nanoparticles and Pt/PdRe/C nanoparticles expressed as the current jₖ in mA/μg at 0.90 V;

FIG. 11 is a plot comparing polarization curves for oxygen reduction on Pt/PdRe/C nanoparticles before (top curve) and after (bottom curve) 10,000 potential cycles; and

FIG. 12 is a schematic showing the principles of operation of a fuel cell in which at least one electrode may be comprised of Pt-encapsulated core-shell nanoparticles, according to the present invention.

### DETAILED DESCRIPTION

These and other objectives of the invention will become more apparent from the following description and illustrative embodiments which are described in detail with reference to the accompanying drawings. In the interest of clarity, in describing the present invention, the following terms and acronyms are defined as provided below.

### ACRONYMS

AES: Auger Electron Spectroscopy
ALD: Atomic Layer Deposition
CVD: Chemical Vapor Deposition
GC: Glassy Carbon
MBE: Molecular Beam Epitaxy
ML: Monolayer
ORR: Oxidation Reduction Reaction
PLD: Pulsed Laser Deposition
PVD: Physical Vapor Deposition
TEM: Transmission Electron Microscope
UPD: Underpotential Deposition
XRD: X-ray Diffraction

### DEFINITIONS

Adatom: An atom located on the surface of an underlying substrate.
Adlayer: A layer (of atoms or molecules) adsorbed to the surface of a substrate.
Atomically Thin Having a thickness of less than one to several monolayers.
Catalysis: A process by which the rate of a chemical reaction is increased by means of a substance (a catalyst) which is not itself consumed by the reaction.
Electrocatalysis: The process of catalyzing a half cell reaction at an electrode surface.
Electrodeposition: Another term for electroplating.
Electrolyte: A substance comprising free ions which behaves as an electrically conductive medium.
Electroplating: The process of using an electrical current to reduce cations of a desired material from solution to coat a conductive substrate with a thin layer of the material.
Monolayer: A single layer (of atoms or molecules) which occupies available surface sites and covers substantially the entire exposed surface of a substrate.
Multilayer: More than one layer (of atoms or molecules) on the surface, with each layer being sequentially stacked on top of the preceding layer.
Nanoparticle: Any manufactured structure or particle with nanometer-scale dimensions (i.e., 1-100 nm).
Noble metal: Metals which are extremely stable and inert, being resistant to corrosion or oxidation. These generally comprise ruthenium (Ru), rhodium (Rh), palladium (Pd), silver (Ag), rhenium (Re), osmium (Os), iridium (Ir), platinum (Pt), and gold (Au). Noble metals are frequently used as a passivating layer.
Non-noble metal: A metal which is not a noble metal.
Redox reaction: A chemical reaction in which an atom undergoes a change in oxidation number. This typically involves the loss of electrons by one entity accompanied by the gain of electrons by another entity.
Refractory metal: A class of metals with extraordinary resistance to heat and wear, but with generally poor resistance to oxidation and corrosion. These generally comprise tungsten (W), molybdenum (Mo), niobium (Nb), tantalum (Ta), and rhenium (Re).
Submonolayer: Surface (atom or molecular) coverages which are less than a monolayer.
Transition metal: Any element in the d-block of the periodic table which includes groups 3 to 12 and IB through VIIIB. Columns 4 through 7 correspond to columns IVB through VIIB, respectively.

The present invention is based on the realization that unwanted dissolution of electrocatalyst particles may be inhibited by inclusion of a material which easily passivates. The passivating element is preferably an element from columns IVB through VIIB of the periodic table (corresponding to groups 4 through 7, respectively) and is such that it forms a stable chemical bond with elements or compounds found within the corrosive environment. This produces non-reactive surface regions which inhibit corrosion of the underlying material constituting the bulk of the particle. This is particularly useful during, for example, application of high electric potentials and exposure to highly corrosive environments. It has been shown that the inclusion of a non-noble metal core in particle alloys and/or core-shell particles reduces the amount of more costly noble metals such as Pt and Pd required while simultaneously providing a large surface area of the more catalytically active noble metal. However, the inadvertent formation of an incomplete noble metal coating or shell may produce pinholes which leave the core constituents exposed to what is typically a corrosive environment. This may inevitably lead to the subsequent dissolution of the non-noble metal component and a degradation of the catalytic properties of the particles. As disclosed in detail below, the inclusion of a passivating component produces high-stability, self-protecting particle alloys and/or core-shell particle electrocatalysts.

The particles disclosed and described in this specification are not limited to any particular shape or size, but are preferably nanoparticles with sizes ranging from 1 to 100 nm in one more dimensions. However, the size is not so limited and may extend into the micrometer and millimeter size range. The shape is preferably spherical or spheroidal, but again is not so limited. Throughout this specification, the particles will be primarily disclosed and described as essentially spherical nanoparticles. It is to be understood, however, that the particles may take on any shape, size, and structure as is well-known in the art. This includes, but is not limited to branching, conical, pyramidal, cubical, mesh, fiber, cuboctahedral, and tubular nanoparticles. The nanoparticles may be agglomerated or dispersed, formed into ordered arrays, fabricated into an interconnected mesh structure, either formed on a supporting medium or suspended in a solution, and may have even or uneven size distributions. The particle shape and size is preferably configured so that the bonding configuration of surface atoms is such that their reactivity and, hence, their ability to function as a catalyst is increased.

### I. Nanoparticle Synthesis

Nanometer-scale particles or nanoparticles have been formed from a wide variety of materials using a number of different techniques which involve both top-down and bottom-up approaches. Examples of the former include standard photolithography techniques, dip-pen nanolithography, and focused ion-beam etching. The latter comprises techniques such as electrodeposition or electroplating on templated substrates, laser ablation of a suitable target, vapor-liquid-solid growth of nanowires, and growth of surface nanostructures by sputtering, chemical vapor deposition (CVD) or molecular beam epitaxy (MBE) from suitable gas precursors and/or solid sources.

Nanoparticles may also be formed using conventional powder-processing techniques such as comminution, grinding, or chemical reactions. Examples of these processes include mechanical grinding in a ball mill, atomization of molten metal forced through an orifice at high velocity, centrifugal disintegration, sol-gel processing, or vaporization of a liquefied metal followed by supercooling in an inert gas stream. Powder-processing techniques are advantageous in that they are generally capable of producing large quantities of nanometer-scale particles with desired size distributions. Chemical routes involve solution-phase growth in which, as an example, sodium boronhydride, superhydride, hydrazine, or citrates may be used to reduce an aqueous or nonaqueous solution comprising salts of a non noble metal and noble metal. Alternatively, the salt mixtures may be reduced using H₂ gas at temperatures ranging from 150 to 1,000° C. These chemical reductive methods can be used, for example, to make nanoparticles of palladium (Pd), gold (Au), rhodium (Rh), iridium (Ir), ruthenium (Ru), osmium (Os), rhenium (Re), nickel (Ni), cobalt (Co), iron (Fe), and combinations thereof. In this specification, two primary types of self-protecting nanoparticles will be discussed and described in detail. The first is nanoparticle alloys while the second is core-shell nanoparticles.

### A. Nanoparticle Alloys

A nanoparticle alloy is generally defined throughout this specification as a nanoparticle comprised of a complete solid solution of two or more elemental metals. The alloy comprises at least one noble metal and at least one element which easily passivates in acidic or alkaline solutions. The relative concentration of each element is dependent on the particular application and desired properties, but is preferably such that a minimum quantity of the passivating element sufficient to form a surface barrier is present in the alloy. The passivating element preferably comprises one or more elements selected from column IVB, VB, VIB, or VIIB (corresponding to groups 4 through 7, respectively) of the periodic table. The passivating element therefore comprises at least one of titanium (Ti), vanadium (V), chromium (Cr), manganese (Mn), zirconium (Zr), niobium (Nb), molybdenum (Mo), technetium (Tc), hafnium (Hf), tantalum (Ta), tungsten (W), and rhenium (Re). These elements have a propensity for forming a stable bond with one or more constituents of acidic or alkaline solutions.

By forming an alloy between one or more passivating metals and the elements comprising the nanoparticle, an electrocatalyst with improved stability may be obtained. Generally, a binary metal alloy comprising a transition metal and a passivating metal may be expressed as Tr₁₋ₓPsₓ where Tr is the transition metal and Ps is the passivating metal. The individual amounts (x) and (1−x) of each element may be adjusted over the range 0<x<1 to obtain a compound with the desired structure, phase, and properties as may be determined from a binary alloy phase diagram of the constituent elements. Examples of noble metal/passivating metal binary alloys include, but are not limited to Pd_{1-X}Tiₓ, Pd₁₋ₓWₓ, Pd₁₋ₓNbₓ, Pd₁₋ₓTaₓ, Pd₁₋ₓReₓ, Pd₁₋ₓIrₓ, Ir₁₋ₓTiₓ, Ir₁₋ₓTaₓ, Ir₁₋ₓNbₓ, Ir₁₋ₓReₓ, Au₁₋ₓTaₓ, Au₁₋ₓIrₓ, and Au₁₋ₓReₓ. Alloys comprising Re as the valve metal are especially preferred since Re is relatively stable and it exhibits excellent solubility with a large number of transition metals, particularly other noble metals.

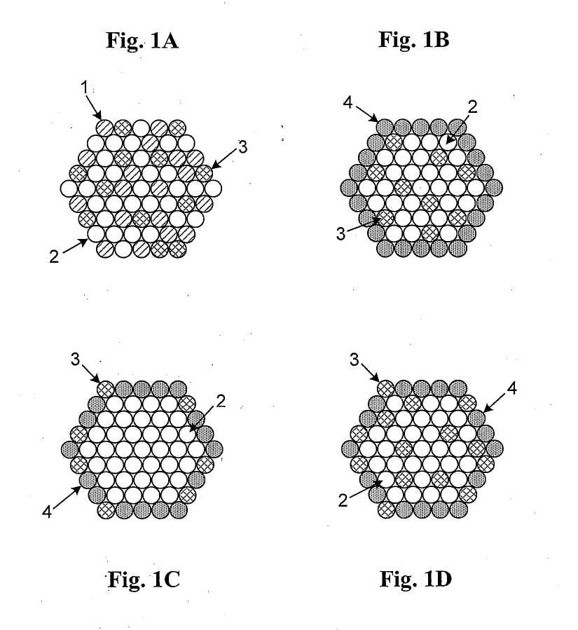

In another embodiment the alloy may comprise one or more of a noble metal, a non-noble metal, and a passivating metal to form a ternary alloy as shown, for example, in FIG. 1A. In this embodiment the nanoparticle alloy is comprised of a solid solution of a noble metal (1), a non-noble metal (2), and a passivating metal (3). The inclusion of a non-noble metal (2) reduces the amount of more costly noble metals (1) which may be required. The non-noble metal may be any transition metal other than the noble metal or passivating metal used in the nanoparticle alloy. A transition metal is defined as any metal within the d-block of the periodic table which corresponds to groups three through twelve. The relative quantities of the non-noble metal (2), passivating metal (3), and noble metal (1) may be optimized to minimize the quantity of precious metals required while simultaneously maximizing the surface catalytic activity and providing an amount of the passivating metal sufficient to produce a self-protecting nanoparticle alloy.

The passivating metal (3) forms a stable bond with one or more constituents of the environment in which the nanoparticle alloy is typically used as a catalyst. This bond effectively passivates surface regions of the nanoparticle in FIG. 1A, forming an impervious layer which physically shields exposed non-noble metal areas of the underlying core from any corrosive environment to which the nanoparticle may be exposed. This passivating layer forms essentially instantaneously over exposed non-noble metal areas due to the strong affinity for forming a stable chemical bond with the passivating metal. The process is analogous to the passivation of Si(001) surfaces during semiconductor lithography by immersion in hydrofluoric acid to form a H-terminated surface which is impervious to oxidation in the ambient. Consequently a nanoparticle alloy may comprise at least one passivating element found within columns IVB through VIIB of the periodic table.

The self-protecting nanoparticle alloys are not limited to homogeneous solid solutions, but may be inhomogeneous. That is, the nanoparticle alloy may not have an even concentration distribution of each element throughout the nanoparticle itself. There may be precipitated phases, immiscible solid solutions, concentration nonuniformities, and some degree of surface segregation. Furthermore, the self-protecting nanoparticle alloys may be formed using any suitable process as previously described. The key aspect is that the passivating metal is present in sufficient quantities near the surface of the nanoparticle alloy to form an impervious surface layer. When used in application such as fuel cells, the improved stability of self-protecting alloys prolongs the service life and improves the performance of the fuel cell. The self-protecting nanoparticle alloys as described above are not limited to fuel cells, but may also be used in any application where nanoparticle catalysts are exposed to a corrosive environment.

### B. Core-Shell Nanoparticles

In another embodiment, the nanostructured substrate may take the form of a non-noble transition metal core which is covered with a thin film of a noble metal. The noble metal shell protects the underlying non-noble core from corrosion during exposure to the acid-based electrolytes used in subsequent processing steps and enables UPD of the intermediary metal (e.g., Cu) during subsequent deposition of a catalytically active overlayer as detailed in Section II below. The combination of core and shell metals used may also be suitably selected to enhance the catalytic properties of the catalytic overlayer. This enhancement may be accomplished by electronic effects and/or by adjusting the lattice parameter of the surface shell to induce strain in the overlayer such that its catalytic activity increases.

Core-shell nanoparticles may be formed using, for example, processes described by J. Zhang, et al. in “Platinum Monolayer on Nonnoble Metal-Noble Metal Core-Shell Nanoparticle Electrocatalysts for O₂ Reduction,” J. Phys. Chem. B. 105, 22 701 (2005) (hereinafter “Zhang”) and U.S. Patent Publ. No. 2007/0031722 to Adzic, et al. the entire contents of both of which are incorporated by reference as if fully set forth in this specification. Initially, a nanoparticle core comprised of a non-noble transition metal such as, for example, nickel (Ni), cobalt (Co), or iron (Fe) along with a noble metal is formed. The non-noble core metals may be used either alone or alloyed with other non-noble transition metals. A core-shell system may be formed from nanoparticles comprising, for example, Ni—Au, Co—Pd, or Co—Pt alloys. Subsequent elevated temperature annealing of nanoparticles formed of these alloys drives surface segregation of the noble metal (e.g., Au, Pd, or Pt). This results in a nanoparticle comprising a non-noble metal core surrounded by a noble metal shell. In another embodiment a nanoparticle core comprised of a single non-noble metal may initially be formed using any of the powder-forming processes detailed above. The non-noble metal core is not limited to Ni, Co, or Fe, but also may be a refractory metal (i.e., W, Mo, Nb, Ta, or Rh). This core may then be covered with a thin shell of Pd, Au, Ru or another noble metal by a suitable process such as electroless deposition or by chemical routes such as atomic layer deposition (ALD) or CVD. An example of a core-shell nanoparticle is shown in FIG. 1B, where a core of a non-noble metal (2) is covered by a noble metal shell (4). The core-shell nanoparticle illustrated in FIG. 1B also contains a passivating metal (3) from group IVB through VIIB within the core and its inclusion is described below.

In some instances the noble metal shell (4) may not completely cover the underlying core. In this case, the non-noble metal (2) component of the core may gradually erode due to reaction within a corrosive environment. By including an element from column IVB, VB, VIB, or VIIB (corresponding to groups 4 through 7, respectively) of the periodic table within either the core, the shell, or both the core and shell, corrosion of the nanoparticle is inhibited. As described in Section A above with reference to nanoparticle alloys, the passivating metal (i.e., Ti, Hf, Zr, W, Ta, Nb, V, Re, Cr, Mo, Tc, or Mn) forms a chemical bond either at the surface of the shell or at surface regions of the core which are not covered by the shell. An example of a core-shell nanoparticle in which a passivating metal (3) has been incorporated with the noble metal shell (4) is shown in FIG. 1C. In FIG. 1D, an example in which the passivating metal (3) is alloyed with both the non-noble metal core (2) and noble metal shell (4) is provided. The inclusion of a passivating element in core-shell particles produces a high-stability, self-protecting nanoparticle catalyst.

In addition to the surface segregation processes used by Zhang and Adzic, a shell of a noble metal or group IVB through VIIB element either alone or alloyed with one or more other transition metals may be formed by other aqueous or vapor-phase processes. For example, a film having a nanoscale thickness (e.g., a nanofilm) may be formed on nanoparticles by a simple electroless deposition process from nonaqueous solutions. The film thickness can be increased by additional conventional electroless deposition processes. Alternatively, an atomically thick shell layer (see, e.g., FIG. 1C) comprising a group IVB, VB, VIB, or VIIB metal may be formed from vapor phase processes such as ALD, CVD, pulsed laser deposition (PLD), or even physical vapor deposition (PVD) techniques such as sputtering, e-beam evaporation, or MBE. In another embodiment the shell may be formed by a cation-adsorption-reduction-metal displacement method as detailed in Section II below. In still another embodiment an oxide nanoparticle of a group IVB, VB, VIB, or VIIB metal may be mixed with PdCl₂ and active carbon then reduced in H₂ at elevated temperatures to produce alloys with surface-segregated Pd layers.

As is the case for nanoparticle alloys, the core-shell nanoparticles may be homogeneous or have their constituents distributed nonuniformly. The key aspect is the presence of a group IVB, VB, VIIB, VIIB metal component around the periphery of the nanoparticle such that a passivating surface layer can be formed in areas where a reactive non-noble metal is exposed. Since this passivating layer forms spontaneously, the core-shell nanoparticle is self-protecting and its stability is significantly increased.

It is to be understood that the methods of forming self-protecting nanoparticles as described above are merely exemplary; a plurality of alternate methods may be employed. The desired composition, structure, and size range may be obtained via suitable adjustment of the processing parameters.

### II. Deposition of a Catalytically Active Thin Film

Nanoparticle formation is followed by the deposition of a catalytically active surface layer having thicknesses in the submonolayer-to-multilayer range. For purposes of this specification, a monolayer (ML) is formed when the surface of a substrate is fully covered by a single, closely packed layer comprising adatoms of a second material which forms a chemical or physical bond with atoms at the surface of the substrate. The surface is considered fully covered when substantially all available surface sites are occupied by an adatom of the second material. If the surface of the substrate is not completely covered by a single layer of the adsorbing material, then the surface coverage is considered to be submonolayer. However, if a second or subsequent layers of the adsorbant are deposited onto the first layer, then multilayer surface coverages (e.g., bilayer, trilayer, etc.) result.

The catalytically active surface layer may be deposited using any of a wide variety of thin film deposition processes which are well-known in the art. These include, but are not limited to, thermal evaporation, chemical vapor deposition (CVD), MBE, PLD, sputtering, and atomic layer deposition (ALD). A majority of these techniques require specialized equipment capable of attaining medium to ultrahigh vacuum conditions and providing precise control over the impinging flux of atoms. Thus, these deposition techniques tend to be prohibitively expensive.

Electrodeposition, on the other hand, is a robust, relatively low-cost deposition technique capable of controllably depositing thin films with thicknesses ranging from submonolayer coverages up to several microns. Electrodeposition may be carried out in aqueous or nonaqueous solutions as well as solutions comprising an ionic liquid. Within this specification it is to be understood that the terms electrodeposition and electroplating may be used interchangeably with each referring to the use of an electrochemical redox reaction to deposit a solid metallic composition onto a substrate from an aqueous or non-aqueous solution. The metallic composition itself may be deposited from a solution comprising a metal ion or a plurality of metal ions using methods well-known to those skilled in the art.

A new synthetic procedure which employs the principles of electrodeposition and galvanic displacement has been utilized by Brankovic, et al. (hereinafter “Brankovic”) to deposit a monolayer of Pt onto Au(111) substrates and by Adzic, et al. (hereinafter “Adzic”) to deposit Pt monolayers onto Pd(111) and carbon-supported Pd nanoparticles. These procedures are described, for example, in “Metal Monolayer Deposition By Replacement Of Metal Adlayers On Electrode Surfaces,” Surf. Sci., 474, L173 (2001) and U.S. Patent Publ. No. 2006/0135359, respectively. This process has also been described in detail by J. Zhang, et al. in “Platinum Monolayer Electrocatalysts for O₂ Reduction: Pt Monolayer On Pd(111) And On Carbon-Supported Pd Nanoparticles,” J. Phys. Chem. B108, 10955 (2004). Each of the aforementioned references is incorporated by reference as if fully set forth in this specification.

The deposition process is centered around a series of electrochemical reactions which, when performed sequentially result in a film with the targeted coverage and composition. The procedure involves the initial formation of an adlayer of a metal onto a substrate by underpotential deposition (UPD). This is followed by the galvanic displacement of the adlayer by a more noble metal, resulting in the conformal deposition of a ML of the more noble metal on the substrate. The overall process involves the irreversible and spontaneous redox displacement of an adlayer of a non-noble metal by a more noble metal. This enables the controlled deposition of a thin, continuous layer of a desired metal. The process requires that the substrate metal be more noble than the metal undergoing deposition in order to avoid becoming oxidized. The redox reaction can be described by the following equation

M_{UPD}⁰+(m/z)L^{z+} [symbol] M^{m+}+(m/z)L⁰ (1)

where M_{UPD}⁰ represents a UPD metal adatom on the electrode surface and L^{z+} is a noble metal cation with positive charge z+ and valence z. The M^{m+} represents the metal cation in the solution obtained after the UPD adatom was oxidized, and L⁰ is a noble atom deposited in the redox process.

Although the catalytically active surface layer is not limited to any particular material, it is preferably Pt due to its excellent catalytic properties. Consequently, an example in which a monolayer of Pt is formed on nanoparticles using the processes described by Brankovic and Adzic will now be described in detail. It is to be understood, however, that the process is not limited to Pt and other noble metals may be utilized. The method involves the initial formation of a monolayer of a metal such as copper (Cu) by underpotential deposition (UPD) in a solution comprised of 50 mM CuSO₄ in a 50 mM H₂SO₄ solution. The Cu-coated nanoparticles are then emersed from solution and rinsed with deionized water to remove Cu²⁺ ions from the surface. This is followed by immersion in a solution comprised of 1.0 mM K₂PtCl₄ in 50 mM H₂SO₄ under a N₂ atmosphere for approximately two minutes to replace all Cu atoms with Pt atoms. The Pt-coated nanoparticle substrate is again rinsed with deionized water. The above processes are carried out in a multi-compartment cell under a N₂ atmosphere in order to prevent Cu oxidation by O₂ during sample transfer.

The above process results in the conformal deposition of a ML of Pt on high-surface-area nanoparticle alloys or core-shell nanoparticles. The deposition cycle comprising UPD of Cu followed by galvanic displacement with Pt may be repeated as needed to produce two or more layers of Pt in order to ensure complete coverage of the nanoparticle surface. Conversely, the UPD of Cu may be controllably limited such that submonolayer coverages of Cu and, hence, Pt are obtained. Deposition of an initial adlayer by UPD may also be accomplished using metals other than Cu such as, for example, lead (Pb), bismuth (Bi), tin (Sn), cadmium (Cd), silver (Ag), antimony (Sb), and thallium (Tl). The choice of metal used for UPD will influence the final Pt surface coverage obtained for a given UPD adlayer. This occurs due to variations in the size and valency among the different metals. The metal overlayer used is not limited to Pt, but may be formed from other noble metals with the only requirement being that the desired metal be more noble than the UPD adlayer. This may be accomplished by contacting the copper-coated particles with their corresponding salts. For example, monolayers of iridium, ruthenium, osmium, and rhenium can be deposited by displacement of a ML of a less noble metal such as copper using IrCl₃, RuCl₃, OsCl₃, or ReCl₃, respectively. Furthermore, the metal overlayer may be formed as an alloy with any number of constituents such as binary, ternary, quaternary, or, quinary alloys with experimentally optimized stoichiometry ratios.

The process offers unprecedented control over film growth and is advantageous in terms of its versatility, reproducibility, and efficient utilization of source material. Since a costly precious metal such as Pt can be utilized as a thin film instead of in bulk form, significant cost savings can be attained. The utilization of a noble metal/substrate nanoparticle may also provide unexpectedly heightened catalytic activity due to synergistic effects between the nanoparticles and the catalytic overlayer. The unexpected increase in catalytic activity may arise due to electronic and geometric effects which arise from the formation of surface metal-metal bonds and the differing lattice constants of the catalytic overlayer and underlying substrate.

The catalytic properties of the surface overlayer may also be engineered by use of a suitable core-shell nanoparticle. A core of a non-noble metal such as Ni, Co, Fe, Ti, W, Nb, V, or Ta may be coated with a more noble metal such as Au, Pd, or Pt. The catalytic activity of the final coated nanoparticle may be controlled by engineering the electronic properties and lattice parameter of the underlying core-shell nanoparticles with respect to those of the metal overlayer.

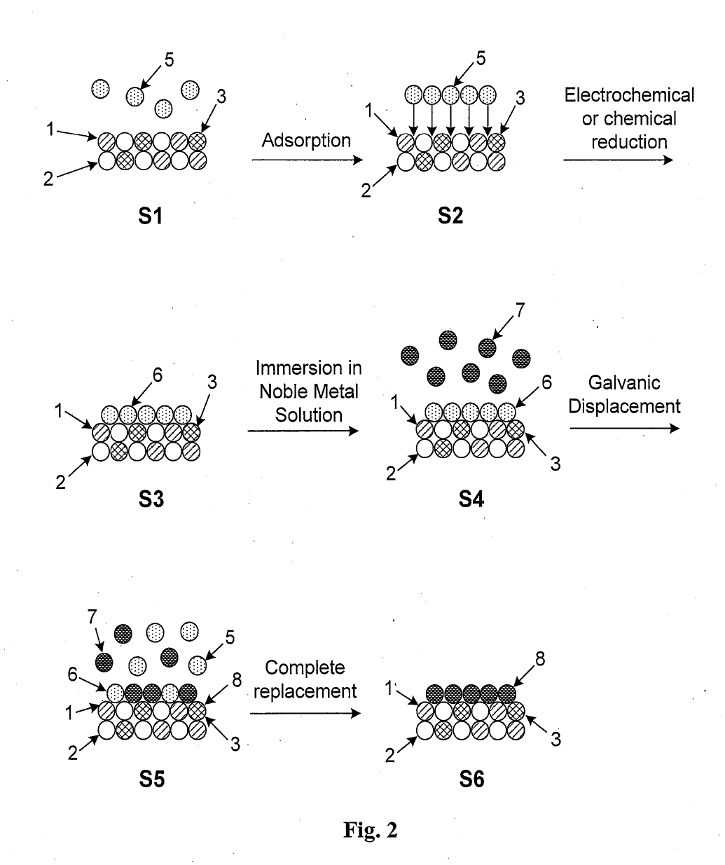

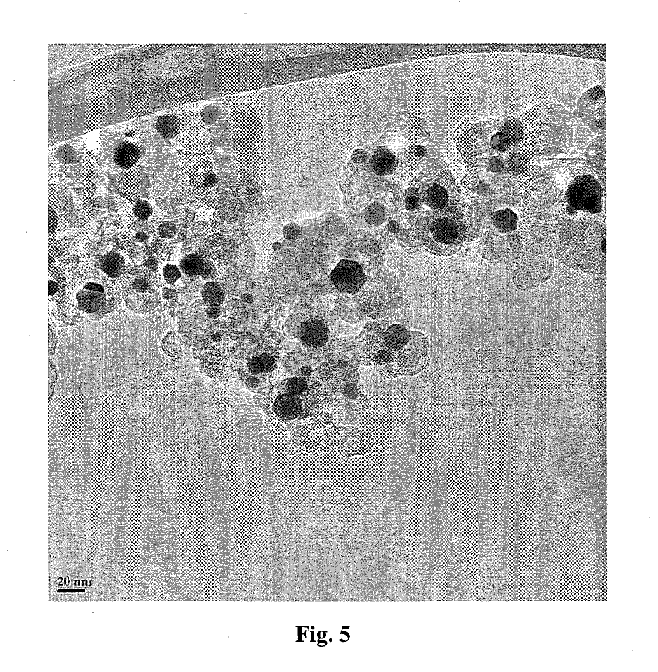

A first general embodiment describing a method of forming a Pt overlayer on the surface of a self-protecting nanoparticle alloy will now be described in detail with reference to FIGS. 2-4. Specific embodiments which exemplify electrocatalyst particles comprising at least one passivating element are provided following the general embodiment in Examples 1 and 2 below. The particle size, microstructure, and activity are analyzed and the results are provided in FIGS. 5-11. Example 1 discloses nanoparticles of a Pd₃Ti alloy whereas Example 2 is directed to PdRe alloy nanoparticles. It is to be understood that these embodiments are merely exemplary and are used to describe a preferred mode of practicing the invention: It is to be further understood that there are many other possible variations which do not deviate from the spirit and scope of the present invention.

### III. Exemplary Embodiments

An exemplary embodiment of the present invention will now be described in detail with reference to FIG. 2 which shows a sequence of surface chemical reactions culminating in the formation of a Pt shell on a high-stability, self-protecting nanoparticle alloy surface. The desired nanoparticles are initially formed using any of the plurality of methods described in Section I above. For purposes of this embodiment, only the first two surface atomic layers of a self-protecting nanoparticle alloy are shown in FIG. 2. The nanoparticle surface in FIG. 2 comprises noble metal atoms (1), a non-noble metal component (2), and a passivating element (3).

Non-noble metal ions of Cu²⁺ (5) are initially adsorbed on the surface by immersing the nanoparticles in a plating bath comprising the appropriate concentration of Cu²⁺ ions (5) in step S1. UPD of Cu results in the adsorption of Cu²⁺ ions (5) on the nanoparticle surface in step S2 and the formation of a monolayer of Cu (6) in step S3. This monolayer forms a continuous Cu “skin” around the periphery of the nanoparticle. The nanoparticle is them emersed from the bath and rinsed with deionized water to remove excess Cu²⁺ (5) ions on the surface. The sample is maintained under a N₂ atmosphere during transfer to inhibit oxidation of the freshly deposited Cu adlayer (6). The nanoparticle is then immersed in a solution comprising a Pt salt in step S4 where Pt²⁺ ions (7) replace surface Cu adatoms (6) via a redox reaction as illustrated in step S5. Since Pt is more noble than Cu, it acts as an oxidizing agent by accepting electrons from Cu. The simultaneous reduction of Pt²⁺ ions to Pt (8) results in the replacement of surface Cu atoms (6) with Pt atoms (8). The final product is a Pt nanoparticle with a “skin” comprising a monolayer of Pt atoms in step S6.

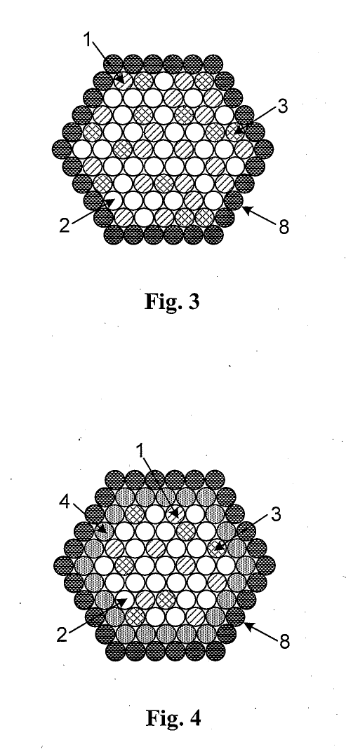

An illustration of a Pt-encapsulated self-protecting nanoparticle alloy and a Pt-encapsulated core-shell nanoparticle are provided in FIGS. 3 and 4, respectively. The cross-section shows that all atoms are close-packed in a hexagonal lattice, resulting in a hexagonal shape. It is to be understood, however, that the crystallographic structure is not limited to that shown and described in FIGS. 3 and 4. Furthermore, the ratio of noble metal (1) and (4), non-noble metal (2), and passivating (3) atoms illustrated in FIGS. 2-4 was arbitrarily chosen to illustrate the principles of the invention. The cycle depicted in FIG. 2 may be repeated any number of times to deposit additional layers of Pt onto the surface of the nanoparticle to ensure complete coverage. Conversely, less than a monolayer of Cu may be deposited during UPD such that submonolayer coverages of Pt result. While only a portion of the surface of a single nanoparticle is illustrated in FIG. 2 it is to be understood that Pt deposition will simultaneously occur on a large number of nanoparticles. The “skin” of Pt atoms will form a continuous and conformal coverage of the entire available surface area.

### Example 1

In another embodiment, carbon-supported Pd—Ti nanoparticle alloys were prepared by dissolving TiCl₄(OC₅H₁₀)₂ powder in dimethyl ether (DME). The resulting solution is mixed with Pd(acac)₂, a thiol, and carbon powder at room temperature. The nominal ratio of Pd to Ti is set as 3:1 in order to produce Pd₃Ti/C nanoparticle alloys. The mixture is then sonicated, stirred at room temperature for two hours, and then dried under an atmosphere of H₂ gas. The resulting powder was then transferred to an oven where it was heated to 900° C. in an Ar/H₂ atmosphere for two hours and cooled to room temperature while maintaining a continuous Ar/H₂ flow. The microstructure of the resulting Pd₃Ti/C nanoparticles was examined by transmission electron microscopy (TEM) and a sample micrograph is provided in FIG. 5. The carbon support is illustrated in FIG. 5 as the lighter-colored background material whereas the Pd₃Ti nanoparticles appear as comparatively darker-colored particles which appear hexagonal in cross-section. The Pd₃Ti particle size ranges from 7 to 30 nm with the average particle size being approximately 20 nm. TEM results also reveal that the particles themselves are substantially in the shape of a cuboctahedron bound predominantly by (111) and (100) planes.

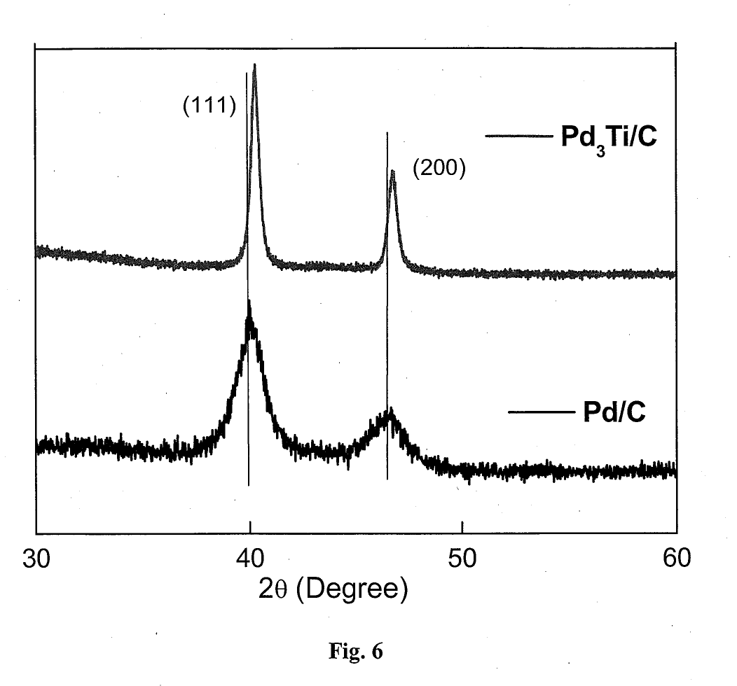

X-ray diffraction (XRD) analyses of the Pd₃Ti nanoparticles between 2θ=30° and 60° (see, e.g., the upper curve in FIG. 6) show relatively narrow (111) and (200) peaks at 2θ˜40° and 47°. An XRD scan obtained from commercial Pd/C is provided as the bottom curve in FIG. 6 for comparison. Compared to Pd nanoparticles (lower curve), Pd₃Ti nanoparticle alloys exhibit sharper and more well-defined Pd(111) and Pd(200) crystalline peaks which are shifted to higher 2θ values. This suggests that, compared to Pd nanoparticles, the Pd₃Ti nanoparticle alloys have a more well-defined crystal structure and sharper surface planes.

A platinum monolayer was deposited onto the Pd₃Ti nanoparticles by redox displacement by platinum of an adlayer of an underpotentially deposited (UPD) metal. In this example, Cu was used as the UPD metal on the Pd₃Ti/C nanoparticle substrate. To prepare an electrode with Pd₃Ti nanoparticles, a dispersion of carbon-supported Pd₃Ti nanoparticles (Pd₃Ti/C) on a carbon substrate was made by sonicating the Pd₃Ti/C nanoparticles in water for about 5-10 minutes to make a uniform suspension. The carbon substrate used was Vulcan XC-72. Then, 5 microliters of this suspension was placed on a glassy carbon disc (GC) electrode and dried in air. The GC electrode holding the Pd₃Ti/C nanoparticles was then placed in a 50 mM CuSO₄/0.1M H₂SO₄ solution to electrodeposit Cu. After electrodeposition of a Cu ML, the electrode was rinsed to remove Cu ions from the electrode. The electrode was then placed in an aqueous solution containing 1.0 mM K₂PtCl₄ in 50 mM H₂SO₄ in a nitrogen atmosphere. After a 1-2 minute immersion to completely replace Cu by Pt, the electrode was rinsed again. The deposition of an atomic ML of Pt on Pd₃Ti nanoparticles was verified by voltammetry and Auger electron spectroscopy (AES). All of these operations were carried out in a multi-compartment cell in a nitrogen atmosphere that prevents the oxidation of Cu adatoms in contact with O₂.

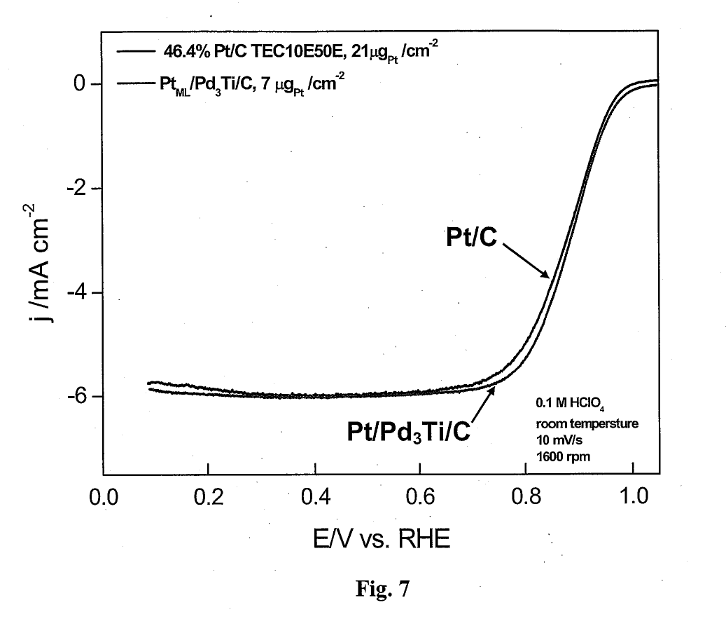

The oxygen reduction electrocatalytic activity of Pt_{ML}/Pd₃Ti/C nanoparticle composites was compared to the electrocatalytic activity of commercially available TEC10E50E 46.4% Pt on Pt nanoparticle catalysts by measuring polarization curves using a rotating disc electrode in a room-temperature solution of 0.1 M HClO₄, a scan speed of 10 mV/s, and a rotation speed of 1600 rpm. Experimental results are shown in FIG. 7, which provides electrocatalytic oxygen reduction curves obtained from Pt/Pd₃Ti/C and commercial Pt nanoparticle catalysts. The activity of the Pt ML on Pd₃Ti nanoparticles is slightly higher than that of Pt nanoparticles. Pt loading for the Pt_{ML}/Pd₃Ti/C nanoparticles is 7 μg_{Pt}/cm² whereas for the commercial Pt/C nanoparticles it is 21 μg_{Pt}/cm².

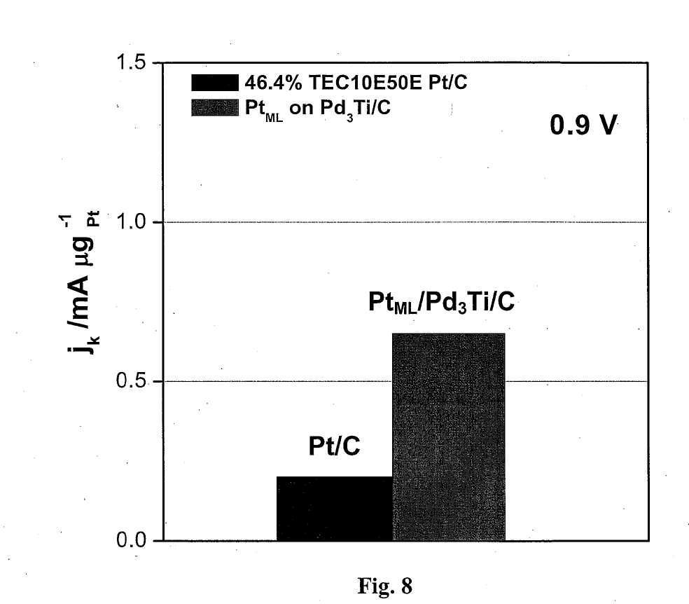

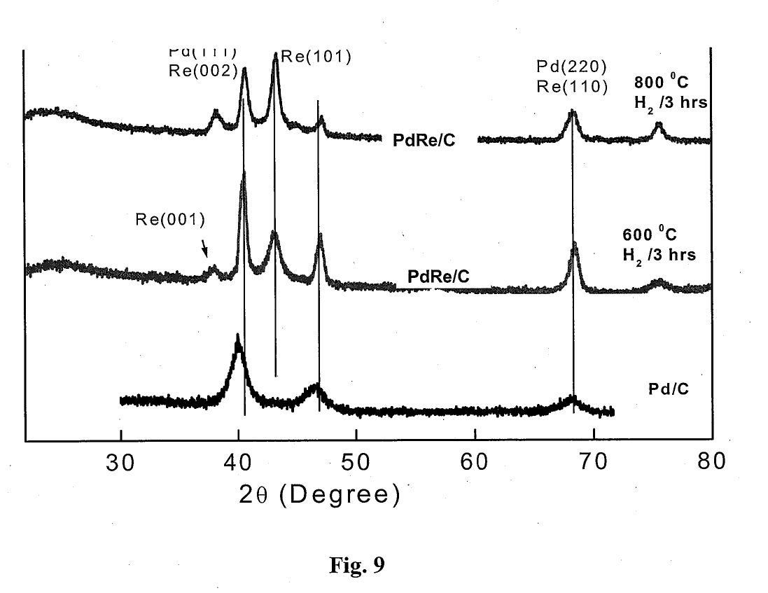

A comparison of the mass-specific activities of Pt_{ML}/Pd₃Ti/C and Pt/C electrocatalysts is displayed in FIG. 8 expressed as the kinetic current jₖ in milliamps per microgram (mA/μg) at 0.90 V divided by the Pt mass. The kinetic current jₖ provides a measure of the activity of the nanoparticles per unit mass of Pt that is included in the nanoparticles. Thus, the higher the value of jₖ, the larger the catalytic activity attained per unit mass of Pt. The electrode having Pt ML particles (Pt_{mL}/Pd₃Ti/C) has a 3.5 to 4.5 times higher mass-specific activity than the electrode with Pt nanoparticles.

### Example 2

In yet another embodiment, carbon-supported Pd—Re nanoparticle alloys (PdRe/C) were prepared in a manner analogous to that described in Example 1. The PdRe/C nanoparticles were prepared by dissolving ReCl₄(OC₅H₁₀)₂ powder in dimethyl ether (DME). The resulting solution is mixed with Pd(acac)₂, a thiol, and carbon powder at room temperature. The ratio of Pd to Re is set as 1:1 in order to produce nanoparticle alloys having equal amounts of Pd and Re. The mixture is then sonicated, stirred at room temperature for two hours, and then dried under an atmosphere of H₂ gas. The resulting powder was then transferred to an oven where it was heated under an H₂ atmosphere to either 800° C. or 600° C. for three hours and then cooled to room temperature while maintaining a continuous H₂ flow.

X-ray diffraction (XRD) analyses of the PdRe/C nanoparticles and commercial Pd/C nanoparticles were obtained over the range 2θ=30° to 70° and the resulting spectra are provided in FIG. 9. The top and middle curves were obtained from separate batches of PdRe nanoparticle alloys annealed at 800° C. and 600° C., respectively, for 3 hours each. An XRD scan obtained from commercial Pd/C is provided as the bottom curve in FIG. 9 for comparison. As was the case for Pd₃Ti nanoparticle alloys, compared to Pd nanoparticles, PdRe nanoparticle alloys exhibit sharper and more well-defined crystalline peaks which are shifted to slightly higher 2θ values. This again suggests that, compared to Pd nanoparticles, the PdRe nanoparticle alloys have a more well-defined crystal structure and sharper surface planes. FIG. 9 shows that the PdRe nanoparticles also exhibit diffraction peaks arising from Re(001), Re(002), Re(101), and Re(110) lattice planes.

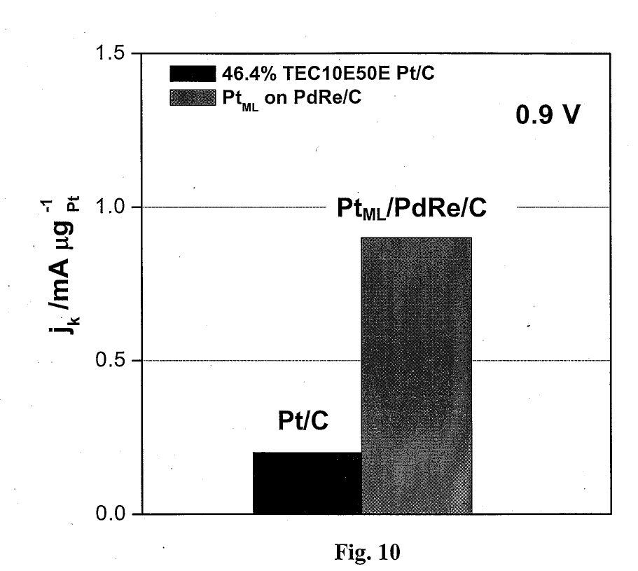

A platinum monolayer was also deposited onto the PdRe nanoparticles by redox displacement by platinum of an adlayer of an underpotentially deposited (UPD) metal. The process followed is identical to that described in Example 1 and will be omitted for brevity. The oxygen reduction electrocatalytic activity of Pt_{ML}/PdRe/C nanoparticle composites was also compared to the electrocatalytic activity of commercially available TEC10E50E 46.4% Pt on Pt nanoparticle catalysts by measuring polarization curves using a rotating disc electrode in a room-temperature solution of 0.1 M HClO₄, a scan speed of 10 mV/s, and a rotation speed of 1600 rpm. A comparison of the mass-specific activities of Pt_{ML}/PdRe/C and Pt/C electrocatalysts is displayed in FIG. 10 expressed as the kinetic current jₖ in milliamps per microgram (mA/μg) at 0.90 V divided by the Pt mass. As was the case for Pt_{ML}/Pd₃Ti/C nanoparticle alloys, the Pt_{ML}/Pd₃Ti/C electrode has a 3.5 to 4.5 times higher mass-specific activity than the electrode with Pt nanoparticles.

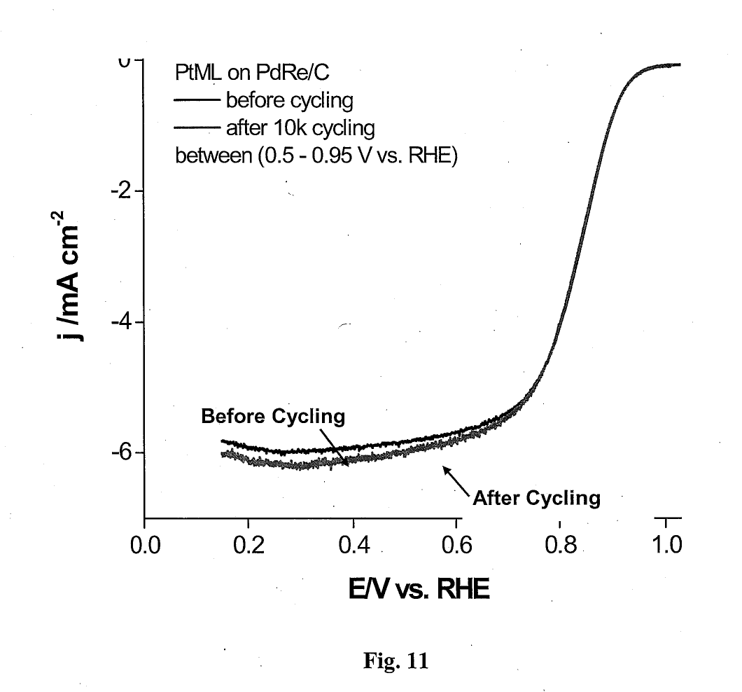

The stability of Pt_{ML}/PdRe/C nanoparticles was investigated by measuring the polarization curves before and after performing repeated potential cycles between 0.5 and 0.95 V. The results are provided in FIG. 11 and show that there is essentially no change in the half wave potential or the overall shape of the polarization curve after performing 10,000 potential cycles. These results indicate that, when compared to a commercial Pt nanoparticle electro catalyst, a Pt-encapsulated nanoparticle core comprising a passivating element exhibits significant improvements in both the catalytic activity and stability.

### IV. Energy Conversion Devices

In a preferred application, the Pt-coated self-protecting nanoparticles as described above may be used as an electrode in a fuel cell. In the event the Pt surface coverage is incomplete, the passivating element (3) present in the nanoparticle may form a stable bond with select elements or compounds from the environment in which is used. This blocks access to the non-noble metal (2) core constituents, thereby inhibiting corrosion of the electrocatalyst nanoparticle support. This application is, however, merely exemplary and is being used to describe a possible implementation of the present invention. Implementation as a fuel cell electrode is described, for example, in U.S. Patent Puble. No. 2006/0135,359 to Adzic. It is to be understood that there are many possible applications which may include, but are not limited to H₂ sensors, charge storage devices, applications which involve corrosive processes, as well as various other types of electrochemical or catalytic devices.

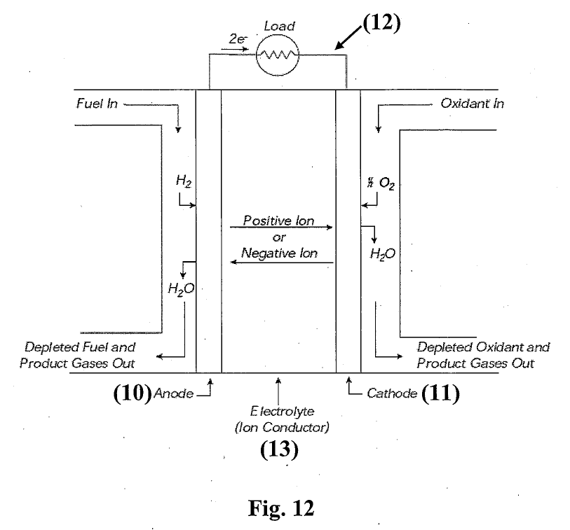

A schematic showing an example of a fuel cell and its operation is provided in FIG. 12. A fuel such as hydrogen gas (H₂) is introduced through a first electrode (10) whereas an oxidant such as oxygen (O₂) is introduced through the second electrode (11). In the configuration shown in FIG. 12, the first electrode (10) is the anode and the second electrode (11) is the cathode. At least one electrode is comprised of Pt-coated core-shell nanoparticles which, in a preferred embodiment, have a non-noble core coated with a shell of a noble metal. Under standard operating conditions electrons and ions are separated from the fuel at the anode (10) such that the electrons are transported through an external circuit (12) and the ions pass through an electrolyte (13). At the cathode (11) the electrons and ions combine with the oxidant to form a waste product which, in this case, is H₂O. The electrical current flowing through the external circuit (12) can be used as electrical energy to power conventional electronic devices. The increase in the ORR attainable through incorporation of Pt-coated core-shell nanoparticles in one or more electrodes will produce an increase in the overall energy conversion efficiency of the fuel cell. Consequently, for a given quantity of fuel, a larger amount of electrical energy will be produced when using Pt-coated core-shell nanoparticle electrodes compared to conventional nanoparticle electrodes.

It will be appreciated by persons skilled in the art that the present invention is not limited to what has been particularly shown and described in this specification. Rather, the scope of the present invention is defined by the claims which follow. It should further be understood that the above description is only representative of illustrative examples of embodiments. For the reader's convenience, the above description has focused on a representative sample of possible embodiments, a sample that teaches the principles of the present invention. Other embodiments may result from a different combination of portions of different embodiments.

The description has not attempted to exhaustively enumerate all possible variations. The alternate embodiments may not have been presented for a specific portion of the invention, and may result from a different combination of described portions, or that other undescribed alternate embodiments may be available for a portion, is not to be considered a disclaimer of those alternate embodiments. It will be appreciated that many of those undescribed embodiments are within the literal scope of the following claims, and others are equivalent. Furthermore, all references, publications, U.S. patents, and U.S. patent application Publications cited throughout this specification are incorporated by reference as if fully set forth in this specification.

1. An electrocatalyst comprising:
a particle comprising an alloy formed with at least one element selected from the group consisting of columns IVB, VB, VIB, and VIIB of the periodic table; and
an atomically thin layer of platinum atoms at least partially encapsulating the particle.

2. The electrocatalyst of claim 1 wherein the particle comprises an element selected from the group consisting of Ti, Hf, Zr, W, Ta, Nb, V, Re, Cr, Mo, Tc, and Mn.

3. The electrocatalyst of claim 1 wherein the particle comprises a binary metal alloy comprising a transition metal and a passivating metal according to the formula Tr₁₋ₓPsₓ where Tr is the transition metal and Ps is the passivating metal and x represents the concentration of Ps, being adjustable over the range 0<x<1.

4. The electrocatalyst of claim 1 wherein the particle comprises an alloy selected from the group consisting of Pd₁₋ₓTiₓ, Pd₁₋ₓWₓ, Pd₁₋ₓNbₓ, Pd₁₋ₓTaₓ, Pd₁₋ₓReₓ, Pd₁₋ₓIrₓ, Ir₁₋ₓTiₓ, Ir₁₋ₓTaₓ, Ir₁₋ₓNbₓ, Ir₁₋ₓReₓ, Au₁₋ₓTaₓ, Au₁₋ₓIrₓ, and Au₁₋ₓReₓ and x represents the concentration of the alloying element, being adjustable over the range 0<x<1.

5. The electrocatalyst of claim 1 wherein the particle comprises a noble metal.

6. The electrocatalyst of claim 5 wherein the particle further comprises a non-noble metal.

7. The electrocatalyst of claim 1 wherein the atomically thin layer of platinum atoms is one to three monolayers thick.

8. The electrocatalyst of claim 1, wherein the particle is a nanoparticle having dimensions of 1 to 100 nm along three orthogonal directions.

9. The electrocatalyst of claim 1, wherein the particle is spherical.

10. An electrocatalyst comprising:
a core at least partially encapsulated by a shell to form a core-shell particle in which the core and shell have different compositions; and
an atomically thin layer of platinum atoms at least partially encapsulating the particle;
wherein at least one of the core or shell is comprised of an alloy formed with at least one element selected from the group consisting of columns IVB, VB, VIB, and VIIB of the periodic table.

11. The electrocatalyst of claim 10 wherein at least one of the core or shell comprises an element selected from the group consisting of Ti, Hf, Zr, W, Ta, Nb, V, Re, Cr, Mo, Tc, and Mn.

12. The electrocatalyst of claim 10 wherein the particle comprises a binary metal alloy comprising a transition metal and a passivating metal according to the formula Tr₁₋ₓPsₓ where Tr is the transition metal and Ps is the passivating metal and x represents the concentration of Ps, being adjustable over the range 0<x<1.

13. The electrocatalyst of claim 10 wherein the particle comprises an alloy selected from the group consisting of Pd₁₋ₓTiₓ, Pd₁₋ₓWₓ, Pd₁₋ₓNbₓ, Pd₁₋ₓTaₓ, Pd₁₋ₓReₓ, Pd₁₋ₓIrₓ, Ir₁₋ₓTiₓ, Ir₁₋ₓTaₓ, Ir₁₋ₓNbₓ, Ir₁₋ₓReₓ, Au₁₋ₓTaₓ, Au₁₋ₓIrₓ, and Au₁₋ₓReₓ and x represents the concentration of the alloying element, being adjustable over the range 0<x<1.

14. The electrocatalyst of claim 10 wherein the core comprises a non-noble metal.

15. The electrocatalyst of claim 14 wherein the shell comprises a noble metal.

16. The electrocatalyst of claim 10 wherein the atomically thin layer of platinum atoms is one to three monolayers thick.

17. The electrocatalyst of claim 10, wherein the particle is a nanoparticle having dimensions of 1 to 100 nm along three orthogonal directions.

18. The electrocatalyst of claim 10 wherein the core-shell particle is spherical.

19. A method of forming electrocatalyst particles comprising:
forming particles comprising a predetermined ratio of atoms of a transition metal and at least one metal selected from the group consisting of columns IVB, VB, VIB, and VIIB of the periodic table;
depositing a contiguous non-noble metal adlayer on a surface of the particles; and
replacing the contiguous non-noble metal adlayer with a noble metal.

20. The method of claim 19 wherein the particle is a nanoparticle having dimensions of 1 to 100 nm along three orthogonal directions.

21. The method of claim 20 wherein the nanoparticles are formed with at least one metal selected from the group consisting of Ti, Hf, Zr, W, Ta, Nb, V, Re, Cr, Mo, Tc, and Mn.

22. The method of claim 19 wherein the particles are formed by dissolving TiCl₄(OC₅H₁₀)₂ powder in dimethyl ether (DME) and mixing the resulting solution with Pd(acac)₂, a thiol, and carbon powder at room temperature.

23. The method of claim 22 wherein the ratio of Pd to Ti is 3:1.

24. The method of claim 22 wherein the particles are sonicated, stirred at room temperature for two hours, and then dried under an H₂ atmosphere.

25. The method of claim 24 wherein the particles are heated to 900° C. in an Ar/H₂ atmosphere for two hours and cooled to room temperature while maintaining a continuous Ar/H₂ flow.

26. The method of claim 19 wherein the particles are formed by dissolving ReCl₄(OC₅H₁₀)₂ powder in dimethyl ether (DME) and mixing the resulting solution with Pd(acac)₂, a thiol, and carbon powder at room temperature.

27. The method of claim 26 wherein the ratio of Pd to Re is 1:1.

28. The method of claim 26 wherein the particles are sonicated, stirred at room temperature for two hours, and then dried under an H₂ atmosphere.

29. The method of claim 28 wherein the particles are heated to 600° C. in an H₂ atmosphere for three hours and cooled to room temperature while maintaining a continuous H₂ flow.

30. The method of claim 28 wherein the particles are heated to 800° C. in an H₂ atmosphere for three hours and cooled to room temperature while maintaining a continuous H₂ flow.

31. The method of claim 20 wherein the nanoparticles are formed by reducing an aqueous suspension comprising a predetermined ratio of a non-noble metal salt and a salt of at least one metal selected from the group consisting of columns IVB, VB, VIB, and VIIB of the periodic table to form particles comprising atoms of a non-noble metal and at least one metal selected from the group consisting of columns IVB, VB, VIB, and VIIB.

32. The method of claim 31 further comprising annealing the nanoparticles to form core-shell nanoparticles comprising a non-noble metal core and a shell comprising at least one metal selected from the group consisting of columns IVB, VB, VIB, and VIIB of the periodic table.

33. The method of claim 31 further comprising forming a shell of a noble metal on the thus-formed nanoparticles.

34. The method of claim 20 wherein the nanoparticles are formed by ball milling, atomization of molten metal forced through an orifice at high velocity, centrifugal disintegration, sol-gel processing, or by vaporization of a liquid metal followed by supercooling in an inert gas stream.

35. The method of claim 19 wherein the contiguous non-noble metal adlayer is deposited by underpotential deposition.

36. The method of claim 35 wherein the contiguous non-noble metal adlayer is selected from the group consisting of Cu, Pb, Bi, Sn, Cd, Ag, Sb, and Tl.

37. The method of claim 19 wherein the contiguous non-noble metal adlayer is replaced by a noble metal by immersing the particles comprising a salt of a noble metal.

38. The method of claim 37 wherein the noble metal salt consists of K₂PtCl₄.
